(19) United States
(12) Patent Application Publication
(10) Pub. No.: US 2011/0195739 A1
(43) Pub. Date: Aug. 11, 2011

(54) COMMUNICATION DEVICE WITH A SPEECH-TO-TEXT CONVERSION FUNCTION

(75) Inventors: Willem Deleus, Boortmeerbeek (BE); Robert Jastram, Asheville, NC (US)

(73) Assignee: Harris Corporation, Melbourne, FL (US)

(21) Appl. No.: 12/703,245

(22) Filed: Feb. 10, 2010

(51) Int. Cl. H04W 4/00; G10L 15/26

(52) U.S. Cl. 455/518; 704/235

(57) ABSTRACT

Systems (100) and methods (800, 900) for communicating information over a network (104). The methods involve receiving group call voice data (GCVD) communicated from a first communication device (102, 504, 704) and addressed to a second communication device (SCD). The GCVD (410, 512, 610, 712) is processed to convert it to text data in response to a condition occurring at SCD (106, 108, 112). The condition is selected from a group consisting of an audio mute condition and a concurrent voice communication condition. The speech-to-text conversion is performed at network equipment (114) and/or SCD. The text data is processed to output text defined thereby on a user interface (230) of SCD. The text data can also be processed to identify at least one word or phrase in the text defined thereby. An indicator can be output using the user interface if the word or phrase is identified in the text.

### BACKGROUND OF THE INVENTION

1. Statement of the Technical Field

The inventive arrangements relate to communication systems, and more particularly to systems and method for providing group calls over a network.

2. Description of the Related Art

There are various communication networks known in the art. Such communication networks include a Land Mobile Radio (LMR) network, a Wideband Code Division Multiple Access (WCDMA) based network, a Code Division Multiple Access (CDMA) based network, a Wireless Local Area Network (WLAN), an Enhanced Data rates for GSM Evolution (EDGE) based network and a Long Term Evolution (LTE) based network. Each of these communication networks comprises a plurality of communication devices and network equipment configured to facilitate communications between the communication devices. Each communication network often provides a group call service to service users. The group call service is a service by which a service user (e.g., first responder) is able to simultaneously talk to other service users (e.g., other first responders) associated with a particular talk group or where a service user (e.g., internet user) is able to simultaneously talk to other service users (e.g., other internet users) associated with a particular social media profile. The group call service can be implemented by a Push-To-Talk (PTT) group call service. The PTT group call service is an instant service by which the PTT service user is able to immediately talk to other PTT service users of a particular talk group or social media profile by pushing a key or button of a communication device.

During operation, the service users may be engaged in a plurality of group calls at the same time. In this scenario, the portable communication devices (e.g., LMR radios and/or cellular telephones) utilized by the service users cannot simultaneously capture speech exchanged between members of the plurality of group calls. For example, if a first portable communication device of a first service user is receiving speech transmitted from a second portable communication device of a second service user of a first talk group or social media profile (or priority talk group), then the first communication device is unable to simultaneously capture speech transmitted from a third communication device of a third service user of a second talk group or social media profile (or non-priority talk group). As such, speech associated with the second talk group or social media profile is undesirably lost.

Also during operation, one or more of the portable communication devices (e.g., LMR radios and/or cellular telephones) may be in their muted state. In the muted state, the audio outputs of the portable communication devices are silenced. In this scenario, the muted, portable communication devices (e.g., LMR radios and/or cellular telephones) are unable to transfer speech of the plurality of group calls to their respective loudspeakers. As such, all information communicated during the group calls is undesirably lost.

Further during operation, one or more of the portable communication devices (e.g., LMR radios and/or cellular telephones) may be used in public safety and/or military covert operations. In this scenario, the service users do not want to be detected by a third party (e.g., an enemy or criminal). As such, the service users can not rely on audible communications. As such, there is a need for portable communication devices (e.g., LMR radios and/or cellular telephones) which provide the service users with a means to receive messages in a discrete manner.

It should also be noted that a console operator (e.g., a 911 operator) utilizing a communication device of a central or dispatch station is able to simultaneously monitor information exchanges between service users of a plurality of talk groups or social media profiles. In this scenario, the speech of the plurality of talk groups or social media profiles is often summed or mixed together to form combined speech. Thereafter, the combined speech from the talk groups or social media profiles that are under active monitoring is concurrently output from a single loud speaker or headset to the console operator. Also, the combined speech from the talk groups or social media profiles that are not under active monitoring is concurrently output from another single loud speaker to the console operator. Consequently, the console operator often has a hard time understanding the speech exchanged between service users of the plurality of talk groups or social media profiles. The console operator may also have difficulty distinguishing which of the service users is speaking at any given time.

### SUMMARY OF THE INVENTION

Embodiments of the present invention concern implementing systems and methods for avoiding loss of data (e.g., speech streams) in a Land Mobile Radio (LMR) communication system in which individual LMR devices are assigned to more than one talk group. Each of the LMR devices can include, but is not limited to, an LMR console or an LMR handset. A first method generally involves receiving a first transmitted voice communication from a first LMR device for a first talk group to which the first LMR device and a second LMR device have been assigned. The first method also involves receiving a second transmitted voice communication from a third LMR device for a second talk group to which the first LMR device and the third LMR device have been assigned. The second transmitted voice communication occurs at a time at least partially concurrent with the first transmitted voice communication. In response to concurrently receiving the first and second transmitted voice communications, at least one action is performed to preserve speech information content of the second transmitted voice communication. At least one signal can be generated to notify a user that the preserving action has been performed.

According to an aspect of the present invention, the action includes converting the speech information content to text and/or storing the speech information content for later presentation at the second LMR device. The speech-to-text conversion can be performed at the second LMR device and/or at a network server remote from the second LMR device. The action also includes displaying the text at the second LMR device. At least one time stamp can be provided for the text. At least one identifier can be provided for associating the text with the third LMR device. The text can be stored for subsequent use. In this scenario, the text can be converted to speech. The speech is presented as audio at the second LMR device.

According to another aspect of the present invention, the first and second transmitted voice communications are automatically converted to text if an audio output of the second LMR device is set to a mute condition.

A second method of the present invention involves receiving a first transmitted voice communication from a first LMR device for a first talk group to which the first LMR device and a second LMR device have been assigned. The second method also involves determining if a condition exists which prevents audio from the first transmitted voice communication from being played over a loudspeaker at the second LMR device. If the condition exists, at least one action is performed for automatically preserving a speech information content of the first transmitted voice communication.

According to an aspect of the present invention, the action involves converting the speech information content to text or storing the speech information content for later presentation at the second LMR device. The speech-to-text conversion can be performed at the second LMR device or a network server remote from the second LMR device. The action also involves displaying the text at the second LMR device. At least one time stamp can be provided for the text. At least one identifier can also be provided for associating the text with the second LMR device. The text can be stored for subsequent use. In this scenario, the text is subsequently converted to speech and presented as audio at the second LMR device.

According to another aspect of the present invention, the condition comprises an audio output of the second LMR device set to a mute condition. Alternatively, the condition comprises receiving a second transmitted voice communication from a third LMR device for a second talk group to which the second LMR device and the third LMR device have been assigned. The second transmitted voice communication occurs at a time at least partially concurrent with the first transmitted voice communication.

A third method of the present invention generally involves receiving a first transmitted voice communication from a first communication device for a first social media profile to which the first communication device and a second communication device have been assigned. The third method also involves receiving a second transmitted voice communication from a third communication device for a second social media profile to which the first communication device and the third communication device has been assigned. The second transmitted voice communication occurs at a time at least partially concurrent with the first transmitted voice communication. In response to concurrently receiving said first and second transmitted voice communications, at least one action is performed to preserve a speech information content of the second transmitted voice communication.

A fourth method of the present invention generally involves receiving a first transmitted voice communication from a first communication device for a first social media profile to which the first communication device and a second communication device have been assigned. The fourth method also involves determining if a condition exists which prevents audio from the first transmitted voice communication from being played over a loudspeaker at the second communication device. If the condition exists, at least one action is performed to automatically preserve a speech information content of the first transmitted voice communication.

### BRIEF DESCRIPTION OF THE DRAWINGS

Embodiments will be described with reference to the following drawing figures, in which like numerals represent like items throughout the figures, and in which:

FIG. 1 is a conceptual diagram of an exemplary communication system that is useful for understanding the present invention.

FIG. 2 is a block diagram of an exemplary communication device that is useful for understanding the present invention.

FIG. 3 is more detailed block diagram of an exemplary computing device that is useful for understanding the present invention.

FIG. 4 is a conceptual diagram of an exemplary process for providing a group call that is useful for understanding the present invention.

FIG. 5 is a conceptual diagram of an exemplary process for providing a group call that is useful for understanding the present invention.

FIG. 6 is a conceptual diagram of an exemplary process for providing a group call that is useful for understanding the present invention.

FIG. 7 is a conceptual diagram of an exemplary process for providing a group call that is useful for understanding the present invention.

FIGS. 8A-8C collectively provide a flow diagram of an exemplary method for providing a group call in which an end user communication device performs a speech-to-text function.

FIGS. 9A-9C collectively provide a flow diagram of an exemplary method for providing a group call in which network equipment performs a speech-to-text function.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

### Exemplary Communication System Implementing the Present Invention

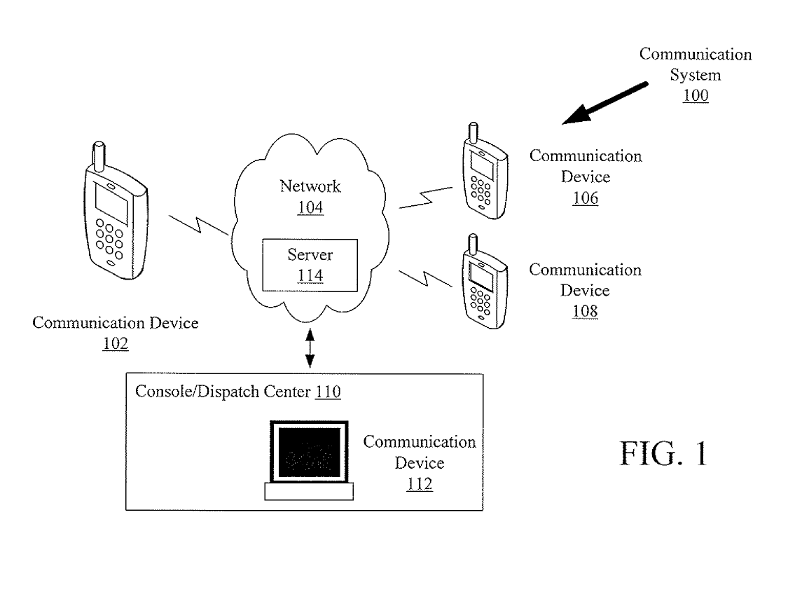

Referring now to FIG. 1, there is provided a block diagram of a communication system 100 that implements one or more method embodiments of the present invention. The communication system 100 can include a Land Mobile Radio (LMR) based system or a cellular based system. If the communication system 100 is a cellular based system, then it can include a second generation (2G) compatible system, a third generation (3G) compatible system and/or a fourth generation (4G) compatible system. The phrase “second generation (2G)”, as used herein, refers to second-generation wireless telephone technology. The phrase “third generation (3G)”, as used herein, refers to third-generation wireless telephone technology. The phrase “fourth generation (4G)”, as used herein, refers to fourth-generation wireless telephone technology. In this scenario, the communication system 100 can support various 2G data services (e.g., text messaging), 3G data services (e.g., video calls) and/or 4G data services (e.g., ultra-broadband internet access). Embodiments of the present invention are not limited in this regard.

The communication system 100 can also employ a single communication protocol or multiple communication protocols. For example, if the communication system 100 is a Land Mobile Radio (LMR) based system, then it can employ one or more of the following communication protocols: a Terrestrial Trunked Radio (TETRA) transport protocol; a P25 transport protocol; an OPENSKY® protocol; an Enhanced Digital Access Communication System (EDACS) protocol; a MPT1327 transport protocol; a Digital Mobile Radio (DMR) transport protocol; and a Digital Private Mobile Radio (DPMR) transport protocol. If the communication system 100 is a cellular network, then it can employ one or more of the following communication protocols: a Wideband Code Division Multiple Access (WCDMA) based protocol; a Code Division Multiple Access (CDMA) based protocol; a Wireless Local Area Network (WLAN) based protocol; an Enhanced Data rates for GSM Evolution (EDGE) network based protocol; and a Long Term Evolution (LTE) network based protocol. Embodiments of the present invention are not limited in this regard.

As shown in FIG. 1, the communication system 100 comprises communication devices 102, 106, 108, a network 104 and a console/dispatch center 110 including a communication device 112. The console/dispatch center 110 can be a stationary center (e.g., a home or an office) or a mobile center (e.g., a vehicle or a supervisor on foot). If the console/dispatch center 110 is a dispatch center, then it can include, but is not limited to, an emergency communication center, an agency communication center, an interagency communication center and any other communication center which provides dispatching and logistical support for personnel management. The console/dispatch center 110 may utilize one or more social media applications (e.g., FACEBOOK® or TWITTER®) for outputting communications from communication devices 102, 106, 108 via chat windows. As should be understood, social media applications typically employ web based messaging. In this scenario, the communication devices 102, 106, 108 may also support web based messaging.

The communication system 100 may include more or less components than those shown in FIG. 1. However, the components shown are sufficient to disclose an illustrative embodiment implementing the present invention. The hardware architecture of FIG. 1 represents one embodiment of a representative communication system configured to provide a group call service to service users. The group call service is a service by which a service user is able to simultaneously talk to other service users associated with a particular talk group or social media profile. The group call service can be implemented by a PTT group call service. The PTT group call service is an instant service by which the PTT service user is able to immediately talk to other PTT service users of a particular talk group or social media profile by pushing a key or button of a communication device (e.g., communication devices 102, 106, 108, 112). Notably, in a group call mode, the communication devices (e.g., communication devices 102, 106, 108, 112) are operating as half duplex devices, i.e., each communication device can only receive a group call communication or transmit a group call communication at any given time. As such, two or more members of a particular talk group or social media profile can not simultaneously transmit group call communications to other members of the talk group or social media profile.

The network 104 allows for communications between the communication devices 102, 106, 108 and/or console/dispatch center 110. As such, the network 104 can include, but is not limited to, servers 114 and other devices to which each of the communication devices 102, 106, 108 and/or console/dispatch center 110 can connect via wired or wireless communication links. Notably, the network 104 can include one or more access points (not shown in FIG. 1) configured to allow disparate communication networks or disparate cellular networks (not shown in FIG. 1) to connect via an intermediary connection (e.g., an internet protocol connection or a packet-switched connection). Embodiments of the present invention are not limited in this regard.

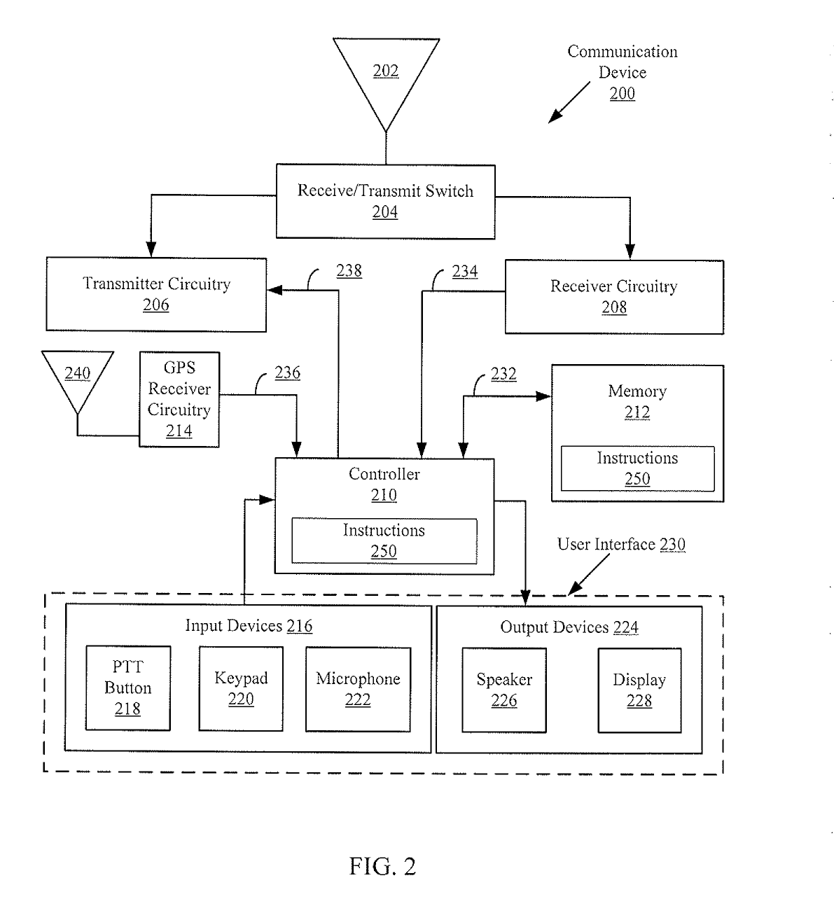

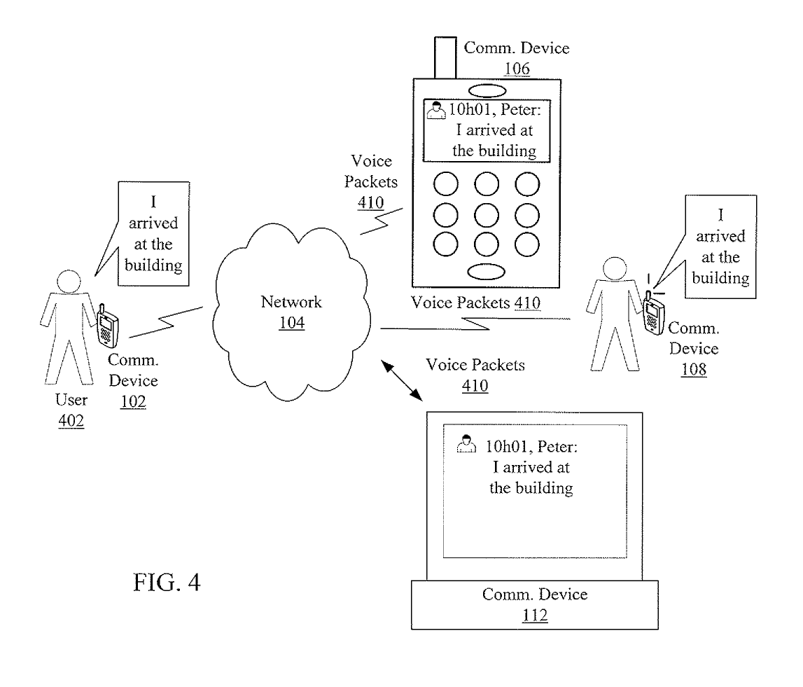

Referring now to FIG. 2, there is provided a detailed block diagram of the communication device 200. The communication devices 102, 106, 108 of FIG. 1 are the same as or similar to the communication device 200. As such, the following discussion of the communication device 200 is sufficient for understanding the communication devices 102, 106, 108 of FIG. 1. Notably, the communication device 200 may include more or less components than those shown in FIG. 2. However, the components shown are sufficient to disclose an illustrative embodiment implementing the present invention. The hardware architecture of FIG. 2 represents one embodiment of a representative communication device configured to facilitate the provision of a group call service to a user thereof. The communication device is also configured to support a speech-to-text conversion function. As such, the communication device of FIG. 2 implements an improved method for providing group calls in accordance with embodiments of the present invention. Exemplary embodiments of the improved method will be described below in relation to FIGS. 4, 5 and 8A-8C.

As shown in FIG. 2, the communication device 200 comprises an antenna 202 for receiving and transmitting Radio Frequency (RF) signals. A receive/transmit (Rx/Tx) switch 204 selectively couples the antenna 202 to the transmitter circuitry 206 and receiver circuitry 208 in a manner familiar to those skilled in the art. The receiver circuitry 208 demodulates and decodes the RF signals received from a network (e.g., the network 104 of FIG. 1) to derive information therefrom. The receiver circuitry 208 is coupled to a controller 210 via an electrical connection 234. The receiver circuitry 208 provides the decoded RF signal information to the controller 210. The controller 210 uses the decoded RF signal information in accordance with the function(s) of the communication device 200.

The controller 210 also provides information to the transmitter circuitry 206 for encoding and modulating information into RF signals. Accordingly, the controller 210 is coupled to the transmitter circuitry 206 via an electrical connection 238. The transmitter circuitry 206 communicates the RF signals to the antenna 202 for transmission to an external device (e.g., network equipment of network 104 of FIG. 1).

An antenna 240 is coupled to Global Positioning System (GPS) receiver circuitry 214 for receiving GPS signals. The GPS receiver circuitry 214 demodulates and decodes the GPS signals to extract GPS location information therefrom. The GPS location information indicates the location of the communication device 200. The GPS receiver circuitry 214 provides the decoded GPS location information to the controller 210. As such, the GPS receiver circuitry 214 is coupled to the controller 210 via an electrical connection 236. The controller 210 uses the decoded GPS location information in accordance with the function(s) of the communication device 200.

The controller 210 stores the decoded RF signal information and the decoded GPS location information in a memory 212 of the communication device 200. Accordingly, the memory 212 is connected to and accessible by the controller 210 through an electrical connection 232. The memory 212 may be a volatile memory and/or a non-volatile memory. For example, the memory 212 can include, but is not limited to, a Random Access Memory (RAM), a Dynamic Random Access Memory (DRAM), a Static Random Access Memory (SRAM), Read-Only Memory (ROM) and flash memory.

As shown in FIG. 2, one or more sets of instructions 250 are stored in the memory 212. The instructions 250 can also reside, completely or at least partially, within the controller 210 during execution thereof by the communication device 200. In this regard, the memory 212 and the controller 210 can constitute machine-readable media. The term “machine-readable media”, as used here, refers to a single medium or multiple media that store the one or more sets of instructions 250. The term “machine-readable media”, as used here, also refers to any medium that is capable of storing, encoding or carrying the set of instructions 250 for execution by the communication device 200 and that cause the communication device 200 to perform one or more of the methodologies of the present disclosure.

The controller 210 is also connected to a user interface 230. The user interface 230 is comprised of input devices 216, output devices 224, and software routines (not shown in FIG. 2) configured to allow a user to interact with and control software applications (not shown in FIG. 2) installed on the computing device 200. Such input and output devices respectively include, but are not limited to, a display 228, a speaker 226, a keypad 220, a directional pad (not shown in FIG. 2), a directional knob (not shown in FIG. 2), a microphone 222 and a PTT button 218. The display 228 may be designed to accept touch screen inputs.

The user interface 230 is operative to facilitate a user-software interaction for launching group call applications (not shown in FIG. 2), PTT call applications (not shown in FIG. 2), speech-to-text conversion applications (not shown in FIG. 2), social media applications, internet applications and other types of applications installed on the computing device 200. The group call and PTT call applications (not shown in FIG. 2) are operative to provide a group call service to a user of the communication device 200. The speech-to-text conversion applications (not shown in FIG. 2) are operative to facilitate: (a) the processing of voice packets for converting speech into text; (b) the storage of text as a text string; (c) the display of the text on a display screen as a scrolling text banner or static content, contents of a chat window or contents of a history window; (d) the display of at least one of a time stamp and a party of a group call, a group image, and/or a group icon associated with the text; (e) the scanning of the text to determine if a pre-defined word and/or phrase is contained therein; (f) the output of an audible and/or visible indicator indicating that the pre-defined word and/or phrase is contained in the text; (g) the triggering of a particular action (e.g., data logging and email forwarding) if the pre-defined word and/or phrase is contained in the text; and/or (h) the ability to export or transport the text to another device.

The PTT button 218 is given a form factor so that a user can easily access the PTT button 218. For example, the PTT button 218 can be taller than other keys or buttons of the communication device 200. Embodiments of the present invention are not limited in this regard. The PTT button 218 provides a user with a single key/button press to initiate a predetermined PTT application or function of the communication device 200. The PTT application facilitates the provision of a PTT service to a user of the communication device 200. As such, the PTT application is operative to perform PTT communication operations. The PTT communication operations can include, but are not limited to, message generation operations, message communication operations, voice packet recording operations, voice packet queuing operations and voice packet communication operations.

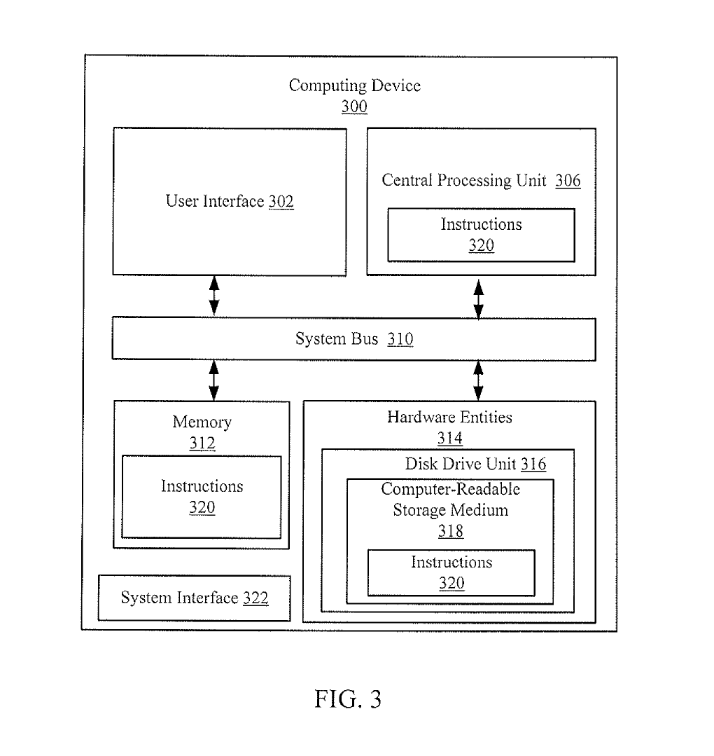

Referring now to FIG. 3, there is provided a more detailed block diagram of a computing device 300 that is useful for understanding the present invention. The server 114 and communication device 112 of FIG. 1 is the same as or similar to the computing device 300. As such, the following discussion of the computing device 300 is sufficient for understanding the server 114 and communication device 112 of FIG. 1. Notably, the computing device 300 may include more or less components than those shown in FIG. 3. However, the components shown are sufficient to disclose an illustrative embodiment implementing the present invention. The hardware architecture of FIG. 3 represents one embodiment of a representative computing device configured to facilitate the provision of a group call service to a user thereof. The computing device is also configured to support a speech-to-text conversion function. As such, the computing device 300 implements an improved method for providing group calls in accordance with embodiments of the present invention. Exemplary embodiments of the improved method will be described in detail below in relation to FIGS. 4-9C.

As shown in FIG. 3, the computing device 300 includes a system interface 322, a user interface 302, a Central Processing Unit (CPU) 306, a system bus 310, a memory 312 connected to and accessible by other portions of computing device 300 through system bus 310, and hardware entities 314 connected to system bus 310. At least some of the hardware entities 314 perform actions involving access to and use of memory 312, which may be a random access memory (RAM), a disk driver and/or a compact disc read only memory (CD-ROM).

System interface 322 allows the computing device 300 to communicate directly or indirectly with external communication devices (e.g., communication devices 102, 106, 108 of FIG. 1). If the computing device 300 is communicating indirectly with the external communication device, then the computing device 300 is sending and receiving communications through a common network (e.g., the network 104 shown in FIG. 1).

Hardware entities 314 may include microprocessors, application specific integrated circuits (ASICs) and other hardware. Hardware entities 314 may include a microprocessor programmed for facilitating the provision of group call services to users thereof. In this regard, it should be understood that the microprocessor can access and run group call applications (not shown in FIG. 3), PTT call applications (not shown in FIG. 3), social media applications (e.g., FACEBOOK® and TWITTER®), internet applications (not shown in FIG. 3), speech-to-text conversion applications (not shown in FIG. 3) and other types of applications installed on the computing device 300. The group call applications (not shown in FIG. 3), PTT call applications (not shown in FIG. 3) and social media applications are operative to facilitate the provision of a group call service to a user of the computing device 300 and/or a remote communication device (e.g., 102, 106, 108). The speech-to-text applications (not shown in FIG. 3) are operative to facilitate: (a) the processing of voice packets for converting speech into text; (b) the storage of text as a text string; (c) the communication of the text to an external communication device; (d) the display of the text on a display screen as a scrolling text banner or static content, contents of a chat window or contents of a history window; (e) the display of at least one of a time stamp, a party of a group call, a group image and/or a group icon associated with the text; (f) the scanning of the text to determine if a pre-defined word and/or phrase is contained therein; (g) the output of an audible and/or visible indicator indicating that the pre-defined word and/or phrase is contained in the text; (h) the triggering of an event (e.g., data logging or email forwarding) if a pre-defined word and/or phrase is contained in the text; and/or (i) the ability to export or transport the text to another device.

As shown in FIG. 3, the hardware entities 314 can include a disk drive unit 316 comprising a computer-readable storage medium 318 on which is stored one or more sets of instructions 320 (e.g., software code) configured to implement one or more of the methodologies, procedures, or functions described herein. The instructions 320 can also reside, completely or at least partially, within the memory 312 and/or within the CPU 306 during execution thereof by the computing device 300. The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the computing device 300 and that cause the computing device 300 to perform any one or more of the methodologies of the present disclosure.

As evident from the above discussion, the communication system 100 implements one or more method embodiments of the present invention. The method embodiments of the present invention provide implementing systems with certain advantages over conventional communication devices. For example, the present invention provides a communication device that can simultaneously capture speech exchanged between members of a plurality of talk groups or social media profiles. The present invention also provides a communication device that can have its audio output muted without losing information communicated during a group call. The present invention further provides a communication device with a means to receive messages in a silent manner (e.g., a text form). The present invention provides a console/dispatch center communication device that can simultaneously output speech associated with a first talk group or social media profile and text associated with a second talk group or social media profile. In effect, the console operator can easily understand the speech exchanged between members of the first talk group or social media profile. The console operator can also easily distinguish from which members of the first and second talk group or social media profile a particular communication is received. The manner in which the above listed advantages of the present invention are achieved will become more evident as the discussion progresses.

### Exemplary Processes for Providing Group Calls Using Communication System 100

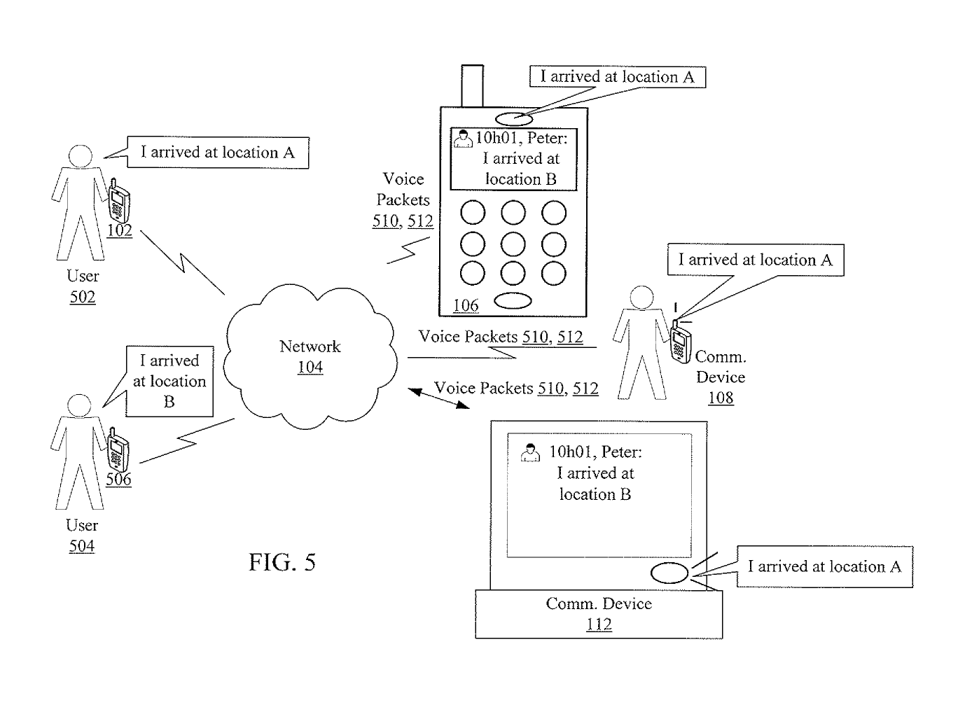

FIGS. 4-5 are intended to illustrate exemplary processes that are useful for understanding the present invention. As evident from FIGS. 4-5, users of the communication devices 106, 108, 112 of FIG. 1 have the ability to enable a speech-to-text conversion function of the communication devices 106, 108, 112. The speech-to-text conversion function can be manually enabled by a user via a menu, a button or other suitable enabling means. The speech-to-text conversion function can also be automatically enabled at the time of configuration of the communication device. The speech-to-text conversion function can further be automatically enabled in response to the reception of an over-the-air signal at the respective communication device 106, 108, 112 and/or in response to a change in system parameters (e.g., a change from a first configuration fill file to a second configuration fill file) of the respective communication device 106, 108, 112. The speech-to-text conversion function can be enabled for all or some of the communications received at the communication devices 106, 108, 112. For example, the speech-to-text conversion function can be enabled for communications that are associated with one or more selected talk groups or social media profiles.

If the speech-to-text conversion function of a communication device 106, 108, 112 is enabled, then the group call communication is displayed as text on a user interface thereof. The text can be displayed in a scrolling text banner, a chat window and/or a history window. A time stamp and/or an identifier of a party to a group call may be displayed along with the text. Also, an audible and/or visible indicator can be output from the communication device 106, 108, 112 if a specific word and/or phrase is contained in the text. Further, a particular event (e.g., data logging or email forwarding) can be triggered if a specific word and/or phrase is contained in the text.

The speech-to-text conversion can be accomplished at a communication device 106, 108, 112 using speech recognition algorithms. Speech recognition algorithms are well known to those having ordinary skill in the art, and therefore will not be described herein. However, it should be understood that any speech recognition algorithm can be used without limitation. For example, a Hidden Markov Model (HMM) based speech recognition algorithm and/or a Dynamic Time Warping (DTW) based speech recognition algorithm can be employed by the communication device 106, 108, 112. Embodiments of the present invention are not limited in this regard.

Referring now to FIG. 4, there is provided a conceptual diagram of a first exemplary process for providing a group call that is useful for understanding the present invention. As shown in FIG. 4, the exemplary process begins when a user 402 of communication device 102 initiates a group call for a talk group “TG-1” or social media profile “SMP-1”. The group call can be initiated by depressing a button of the communication device 102 (e.g., the PTT button 218 of FIG. 2). After initiating the group call, the user 402 speaks into the communication device 102. In response to the reception of a voice signal at the communication device 102, the communication device 102 processes the signal to generate voice packets. The voice packets 410 are communicated from the communication device 102 to the communication devices 106, 108, 112 via network 104. Notably, communication devices 106, 108 are members of the talk group “TG-1” or social media profile “SMP-1”.

At the communication device 106, the voice packets 410 are processed to convert speech to text. The text is displayed in an interface window of a display screen (e.g., display screen 228 of FIG. 2) of the communication device 106. The interface window can include, but is not limited to, a scrolling text banner, a chat window and a history window. As shown in FIG. 4, a time stamp (e.g., “10h01”) and an identifier of a member of the talk group or social media profile (e.g., “Peter”) are also displayed on the display screen (e.g., display screen 228 of FIG. 2). The identifier can include, but is not limited to, a textual identifier (as shown in FIG. 4), a numeric identifier, a symbolic identifier, an icon based identifier, a color based identifier and/or any combination thereof. Notably, the communication device 106 is in its muted state and/or has its speech-to-text conversion function enabled at least for the talk group “TG-1” or social media profile “SMP-1”. In the muted state, the audio outputs of the portable communication device 106 is muted.

At the communication device 108, the voice packets 410 are processed for outputting voice from a speaker (e.g., speaker 226 of FIG. 2) of the communication device 108. Notably, the communication device 108 is not in its muted state. Also, the communication device 108 does not have its speech-to-text conversion function enabled.

At the console/dispatch center communication device 112, the voice packets 410 are processed to convert speech to text. The text is displayed on a user interface (e.g., user interface 302 of FIG. 3) of the communication device 112. As shown in FIG. 4, a time stamp (e.g., “10h01”) and an identifier of a member of the talk group or social media profile (e.g., “Peter”) are also displayed in an interface window of the user interface (e.g., user interface 302 of FIG. 3). The interface window can include, but is not limited to, a scrolling text banner, a chat window and a history window. The identifier can include, but is not limited to, a textual identifier (as shown in FIG. 4), a numeric identifier, a symbolic identifier, an icon based identifier, a color based identifier and/or any combination thereof. Notably, the communication device 112 is monitoring communications associated with one or more talk groups or social media profiles. The communication device 112 also has its speech-to-text conversion function enabled for select talk groups (including talk group “TG-1”) or social media profiles (including social media profile “SMP-1”).

Referring now to FIG. 5, there is provided a conceptual diagram of a second exemplary process for providing a group call that is useful for understanding the present invention. As shown in FIG. 5, the process begins when a user 502 of communication device 102 initiates a group call for a high priority talk group “HTG-1” or high priority social media profile “HSMP-1”. The group call can be initiated by depressing a button of the communication device 102 (e.g., the PTT button 218 of FIG. 2). After initiating the group call, the user 402 speaks into the communication device 102. In response to the reception of a voice signal at the communication device 102, the communication device 102 processes the signal to generate voice packets 510. The voice packets 510 are communicated from the communication device 102 to the communication devices 106, 108, 112 via network 104.

A user 504 of a communication device 506 also initiates a group call for a low priority talk group “LTG-2” or low priority social media profile “LSMP-2”. The group call can be initiated by depressing a button of the communication device 506 (e.g., the PTT button 218 of FIG. 2). After initiating the group call, the user 504 speaks into the communication device 506. In response to the reception of a voice signal at the communication device 506, the communication device 506 processes the signal to generate voice packets 512. The voice packets 512 are communicated from the communication device 506 to the communication devices 106, 108, 112 via network 104.

At the communication device 106, the voice packets 510 are processed for outputting voice associated with a member of the high priority talk group “HTG-1” or high priority social media profile “HSMP-1” from a speaker (e.g., speaker 226 of FIG. 2) of the communication device 106. The voice packets 512 are processed to convert speech to text. The text associated with the low priority talk group “LTG-2” or low priority social media profile “LSMP-2” is displayed in an interface window of a display screen (e.g., display screen 228 of FIG. 2) of the communication device 106. The interface window can include, but is not limited to, a scrolling text banner, a chat window and a history window. A time stamp (e.g., “10h01”) and an identifier of a member of the low priority talk group “LTG-2” or low priority social media profile “LSMP-2” (e.g., “Peter”) can also be displayed in the interface window of the display screen (e.g., display screen 228 of FIG. 2). The identifier can include, but is not limited to, a textual identifier (as shown in FIG. 5), a numeric identifier, a symbolic identifier, an icon based identifier, a color based identifier and/or any combination thereof. Notably, the communication device 106 is not in a muted state. The communication device 106 has its speech-to-text conversion function enabled.

At the communication device 108, the voice packets 510 are processed for outputting voice associated with the high priority talk group “LTG-1” or high priority social media profile “LSMP-1” from a speaker (e.g., speaker 226 of FIG. 2) of the communication device 108. However, the voice packets 512 associated with the low priority talk group “LTG-2” or low priority social media profile “LSMP-2” are discarded or stored. If the voice packets 512 are stored, then they can be subsequently processed by the communication device 108 for conversion of speech to text, and/or for subsequent output of audio. Notably, the communication device 108 is not in its muted state. The communication device 108 also does not have its speech-to-text conversion function enabled.

At the communication device 112, the voice packets 510 are processed for outputting voice associated with the high priority talk group “HTG-1” or high priority social media profile “HSMP-1” from a user interface (e.g., user interface 302 of FIG. 3) of the communication device 112. However, the voice packets 512 associated with the low priority talk group “LTG-2” or low priority social media profile “LSMP-2” are processed to convert speech to text. The text associated with the low priority talk group “LTG-2” or low priority social media profile “LSMP-2” is displayed in an interface window of a display screen (as shown in FIG. 5) of the communication device 112. The interface window can include, but is not limited to, a scrolling text banner, a chat window and a history window. A time stamp (e.g., “10h01”) and an identifier of a member of the low priority talk group “LTG-2” or low priority social media profile “LSMP-2” (e.g., “Peter”) can also be displayed in the interface window of the display screen. The identifier can include, but is not limited to, a textual identifier (as shown in FIG. 5), a numeric identifier, a symbolic identifier, an icon based identifier, a color based identifier and/or any combination thereof. Notably, the communication device 112 is monitoring communications associated with one or more talk groups or social media profiles. The communication device 112 also has its speech-to-text conversion function enabled for select talk groups (including low priority talk group “LTG-2”) or select social media profiles (include low priority social media profile “LSMP-2”).

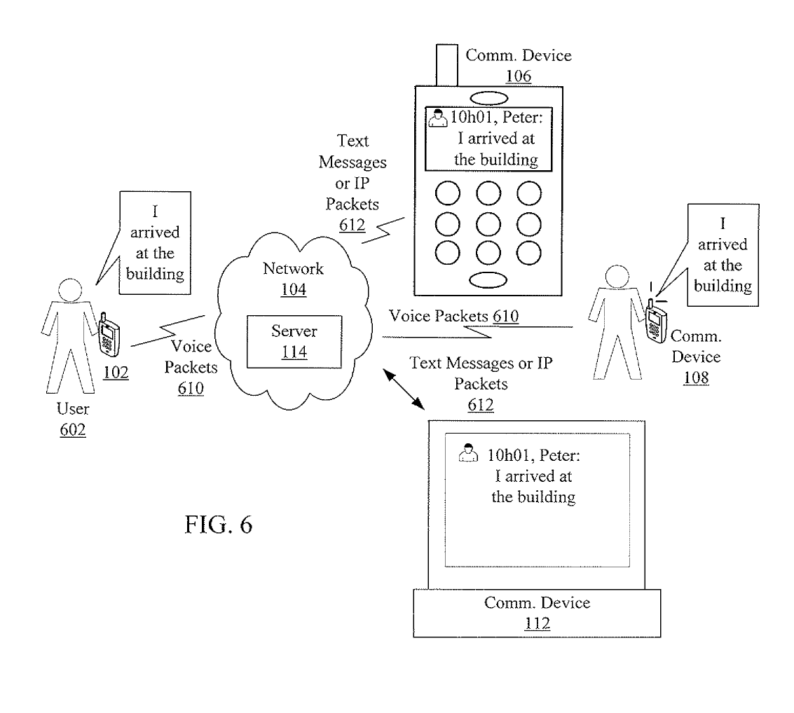

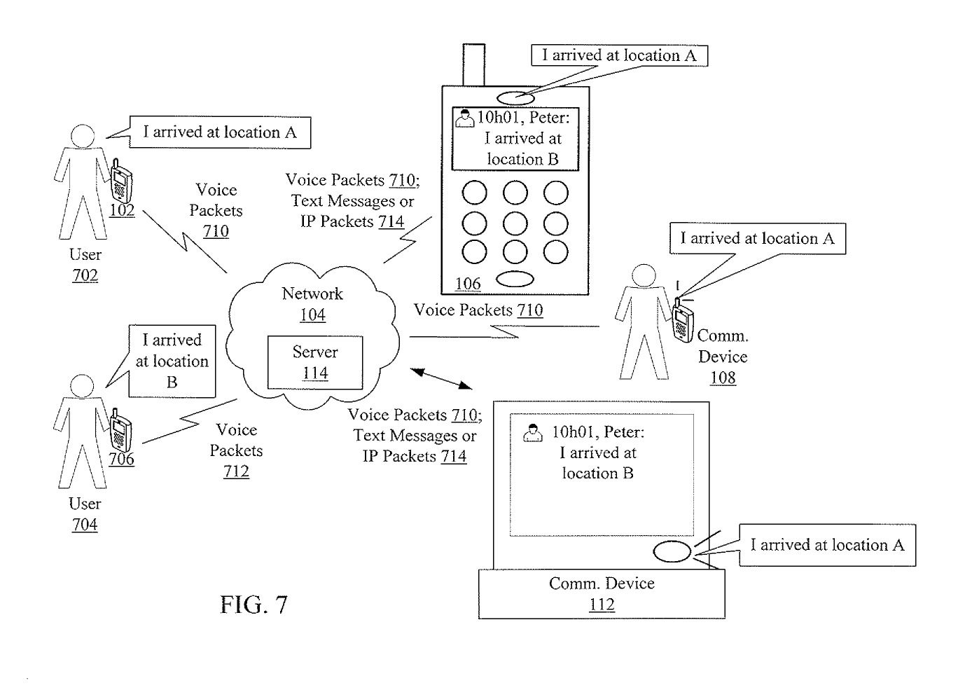

FIGS. 6-7 are intended to illustrate exemplary processes for providing group calls that are useful for understanding the present invention. As evident from FIGS. 6-7, network equipment (e.g., server 114) of network 104 of FIG. 1 implements a speech-to-text conversion function. The speech-to-text conversion function is employed when the network 104 of FIG. 1 receives a communication addressed to a communication device 106, 108, 112 that has its speech-to-text conversion function enabled. If the speech-to-text conversion function of the network 104 is employed, then voice packets are processed for converting speech to text. The text is then communicated from the network 104 to the communication device that has its speech-to-text conversion function enabled. In this regard, it should be understood that the communication device is configured to send a communication to the network 104 indicating that its speech-to-text conversion function has been enabled or disabled for one or more talk groups or social media profiles. The network 104 includes a storage device for keeping track of which communication devices have their speech-to-text conversion functions enabled for one or more talk groups or social media profiles.

Also in some embodiments, the text is analyzed at the network 104 to determine if a word and/or a phrase is contained therein. If the word and/or phrase is contained in the text, then the network 104 generates a command message for outputting an audible and/or visible indicator. The network 104 may also generate a command to trigger an event (e.g., data logging or email forwarding) if the word and/or phrase is contained in the text. The command message(s) is(are) communicated from the network 104 to the communication device. In response to the command message(s), an indicator is output and/or an event is triggered by the communication device.

The speech-to-text conversion can be accomplished at the network 104 using speech recognition algorithms. Speech recognition algorithms are well known to those having ordinary skill in the art, and therefore will not be described herein. However, it should be understood that any voice recognition algorithm can be used without limitation. For example, a Hidden Markov Model (HMM) based speech recognition algorithm and/or a Dynamic Time Warping (DTW) based speech recognition algorithm can be employed by the network 104. Embodiments of the present invention are not limited in this regard.

Referring now to FIG. 6, there is provided a conceptual diagram of a third exemplary process for providing a group call that is useful for understanding the present invention. As shown in FIG. 6, the exemplary process begins when a user 602 of communication device 102 initiates a group call for a talk group “TG-1” or social media profile “SMP-1”. The group call can be initiated by depressing a button of the communication device 102 (e.g., the PTT button 218 of FIG. 2). After initiating the group call, the user 602 speaks into the communication device 102. In response to the reception of a voice signal at the communication device 102, the communication device 102 processes the signal to generate voice packets 610. The voice packets 610 are communicated from the communication device 102 to the network 104. The voice packets 610 are addressed to the communication devices 106, 108, 112.

At the network 104, the voice packets 610 are processed to convert speech to text. The network 104 forwards voice packets 610 to communication device 108 which does not have its speech-to-text function enabled. The network 104 communicates the text in text messages or IP packets 612 to the communication devices 106, 112 which have their speech-to-text conversion function enabled at least for the talk group “TG-1” or social media profile “SMP-1”. Notably, the network 104 can also store the voice packets 610 and/or text messages or IP packets 612 for subsequent processing by the network 104 and/or for subsequent retrieval by communication devices 106, 108, 112.

At the communication device 106, the text messages or IP packets 612 are processed for outputting text to a user thereof. As shown in FIG. 6, the text is displayed in an interface window of a display screen (e.g., display screen 228 of FIG. 2) of the communication device 106. The interface window can include, but is not limited to, a scrolling text banner, a chat window and a history window. A time stamp (e.g., “10h01”) and an identifier of a member of the talk group or social media profile (e.g., “Peter”) are also displayed on the display screen (e.g., display screen 228 of FIG. 2). The identifier can include, but is not limited to, a textual identifier (as shown in FIG. 6), a numeric identifier, a symbolic identifier, an icon based identifier, a color based identifier and/or any combination thereof. Notably, the communication device 106 is in its muted state and/or has its speech-to-text conversion function enabled at least for the talk group “TG-1” or social media profile “SMP-1”. In the muted state, the audio output of the portable communication device 106 is muted.

At the communication device 108, the voice packets 610 are processed for outputting voice from a speaker (e.g., speaker 226 of FIG. 2) of the communication device 108. Notably, the communication device 108 is not in its muted state. Also, the communication device 108 does not have its speech-to-text conversion function enabled.

At the dispatch center communication device 112, the text messages or IP packets 612 are processed to output text to a user thereof. The text is displayed on a user interface (e.g., user interface 302 of FIG. 3) of the communication device 112. A time stamp (e.g., “10h01”) and an identifier of a member of a talk group or social media profile (e.g., “Peter”) are also displayed in an interface window of the user interface (e.g., user interface 302 of FIG. 3). The interface window can include, but is not limited to, a scrolling text banner, a chat window and a history window. The identifier can include, but is not limited to, a textual identifier (as shown in FIG. 6), a numeric identifier, a symbolic identifier, an icon based identifier, a color based identifier and/or any combination thereof. Notably, the communication device 112 is monitoring communications associated with one or more talk groups or social media profiles. The communication device 112 also has its speech-to-text conversion function enabled for select talk groups (including talk group “TG-1”) or select social media profiles (including social media profile “SMP-1”).

Referring now to FIG. 7, there is provided a conceptual diagram of a fourth exemplary process for providing a group call that is useful for understanding the present invention. As shown in FIG. 7, the process begins when a user 702 of communication device 102 initiates a group call for a high priority talk group “HTG-1” or high priority social media profile “HSMP-1”. The group call can be initiated by depressing a button of the communication device 102 (e.g., the PTT button 218 of FIG. 2). After initiating the group call, the user 702 speaks into the communication device 102. In response to the reception of a voice signal at the communication device 102, the communication device 102 processes the signal to generate voice packets 710. The voice packets 710 are communicated from the communication device 102 to the network 104. The voice packets 710 are addressed to the communication devices 106, 108, 112.

A user 704 of a communication device 706 also initiates a group call for a low priority talk group “LTG-2” or a low priority social media profile “LSMP-2”. The group call can be initiated by depressing a button of the communication device 706 (e.g., the PTT button 218 of FIG. 2). After initiating the group call, the user 704 speaks into the communication device 706. In response to the reception of a voice signal at the communication device 706, the communication device 706 processes the signal to generate voice packets 712. The voice packets 712 are communicated from the communication device 706 to the network 104. The voice packets 712 are addressed to the communication devices 106, 108, 112.

The network 104 forwards the voice packets 710 associated with the high priority talk group “HTG-1” or high priority social media profile “HSMP-1” to the communication devices 106, 108, 112. However, the network 104 processes the voice packets 712 associated with a low priority talk group “LTG-2” or low priority social media profile “LSMP-2” to convert speech to text. The network 104 communicates the text in text messages or IP packets 714 to the communication devices 106, 112 which have their speech-to-text conversion function enabled at least for the low priority talk group “LTG-2” or low priority social media profile “LSMP-2”. The network 104 can also store the voice packets 710 and/or 712 for subsequent processing by the network 104 for conversion of speech to text, and/or for subsequent retrieval by communication devices 106, 108, 112. The network 104 can also store the text messages or IP packets 714 for subsequent retrieval and processing.

At the communication device 106, the voice packets 710 are processed for outputting voice associated with a member of the high priority talk group “HTG-1” or high priority social media profile “HSMP-1” to a user thereof. The voice can be output from a speaker (e.g., speaker 226 of FIG. 2) of the communication device 106. The text messages or IP packets 714 are processed to output text associated with the low priority talk group “LTG-2” or low priority social media profile “LSMP-2” to the user thereof. The text associated with the low priority talk group “LTG-2” or low priority social media profile “LSMP-2” is displayed in an interface window of a display screen (e.g., display screen 228 of FIG. 2) of the communication device 106. The interface window can include, but is not limited to, a scrolling text banner, a chat window and a history window. A time stamp (e.g., “10h01”) and an identifier of a member of the low priority talk group “LTG-2” or low priority social media profile “LSMP-2” (e.g., “Peter”) can also be displayed in the interface window of the display screen (e.g., display screen 228 of FIG. 2). The identifier can include, but is not limited to, a textual identifier (as shown in FIG. 7), a numeric identifier, a symbolic identifier, an icon based identifier, a color based identifier and/or any combination thereof. Notably, the communication device 106 is not in its muted state and has its speech-to-text conversion function enabled at least for the low priority talk group “LTG-2” or low priority social media profile “LSMP-1”.

At the communication device 108, the voice packets 710 are processed for outputting voice associated with the high priority talk group “HTG-1” or high priority social media profile “HSMP-1” to a user thereof. The voice can be output from a speaker (e.g., speaker 226 of FIG. 2) of the communication device 108. Notably, if the voice packets 712 associated with the low priority talk group “LTG-2” or low priority social media profile “LSMP-2” are also communicated from the network 104 to the communication device 108, then the communication device 108 can discard the voice packets 712 or store the same in a storage device thereof for subsequent retrieval and processing. Notably, the communication device 108 is not in its muted state. The communication device 108 also does not have its speech-to-text conversion function enabled.

At the communication device 112, the voice packets 710 are processed for outputting voice associated with the high priority talk group “HTG-1” or high priority social media profile “HSMP-1” to a user thereof. The voice can be output from a user interface (e.g., a user interface 302 of FIG. 3) of the communication device 112. The text messages or IP packets 714 associated with the low priority talk group “LTG-2” or low priority social media profile “LSMP-2” are processed to output text to the user of the communication device 112. The text associated with the low priority talk group “LTG-2” or low priority social media profile “LSMP-2” is displayed in an interface window of a display screen (as shown in FIG. 7) of the communication device 112. The interface window can include, but is not limited to, a scrolling text banner, a chat window and a history window. A time stamp (e.g., “10h01”) and an identifier of a member of the low priority talk group “LTG-2” or low priority social media profile “LSMP-2” (e.g., “Peter”) can also be displayed in the interface window of the display screen. The identifier can include, but is not limited to, a textual identifier (as shown in FIG. 7), a numeric identifier, a symbolic identifier, an icon based identifier, a color based identifier and/or any combination thereof. Notably, the communication device 112 is monitoring communications associated with one or more talk groups or social media profiles. The communication device 112 also has its speech-to-text conversion function enabled for select talk groups (including low priority talk group “TG-2”) or select social media profiles (including low priority social media profile “SMP-2”).

### Exemplary Method Embodiments of the Present Invention

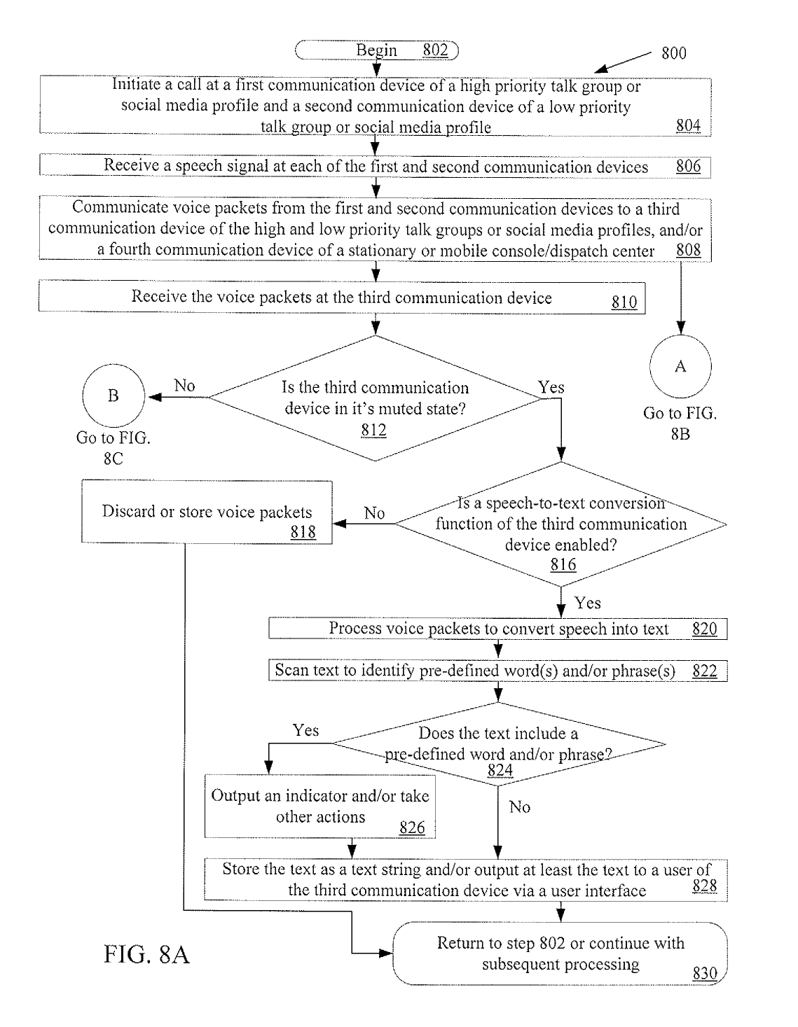

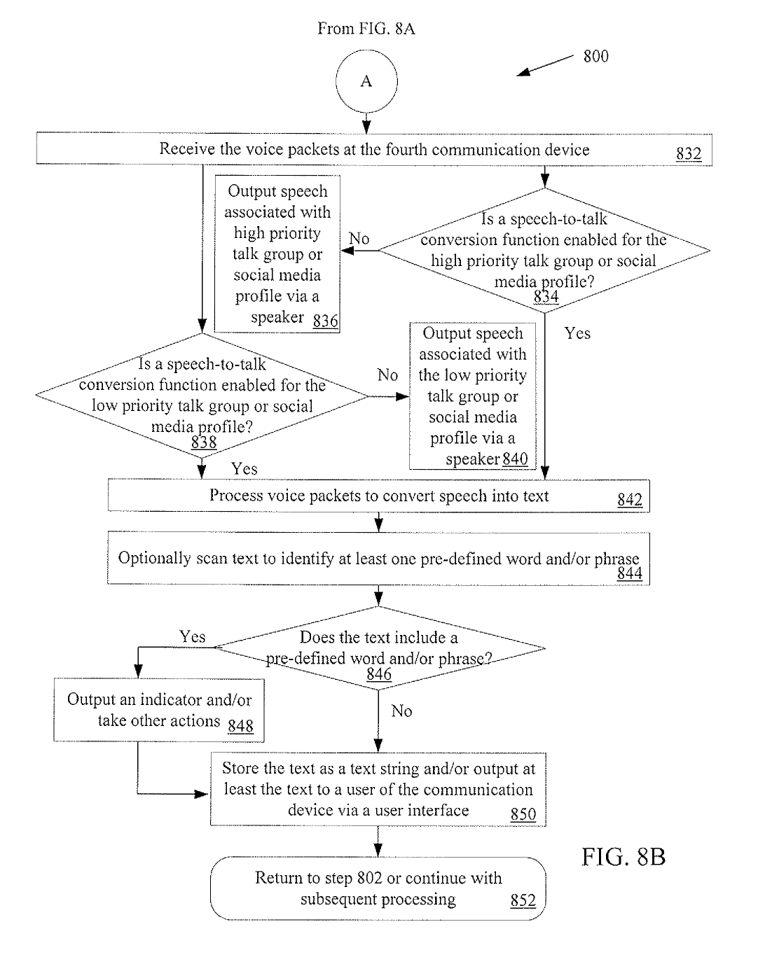

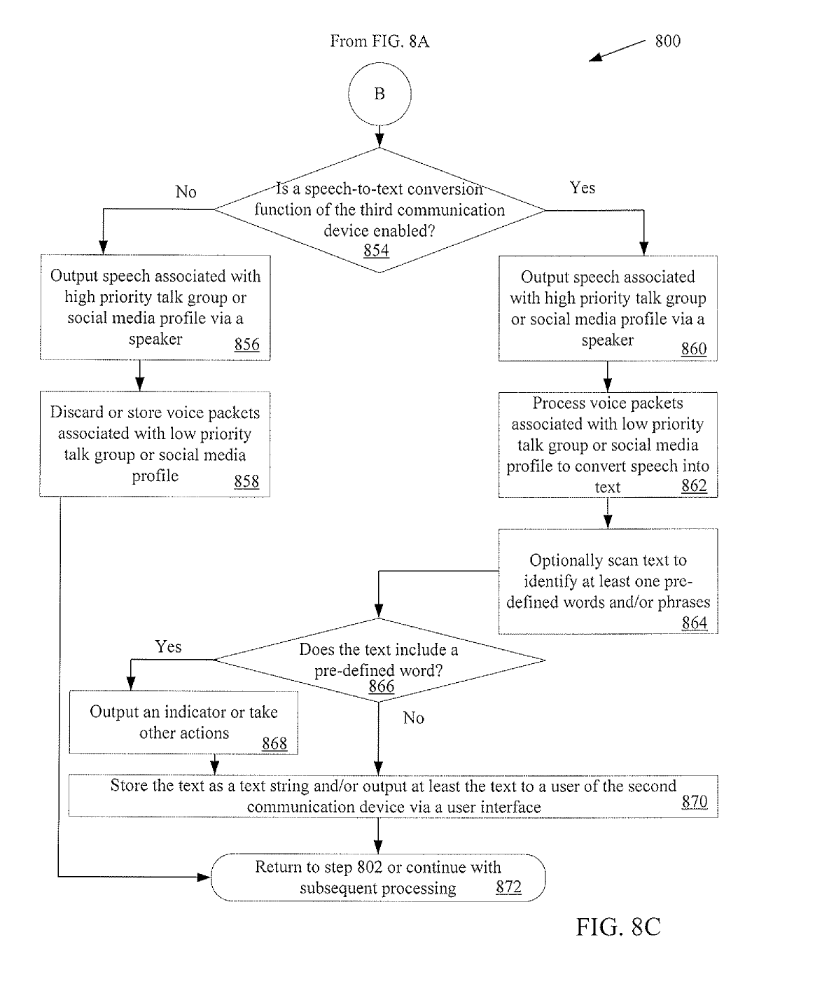

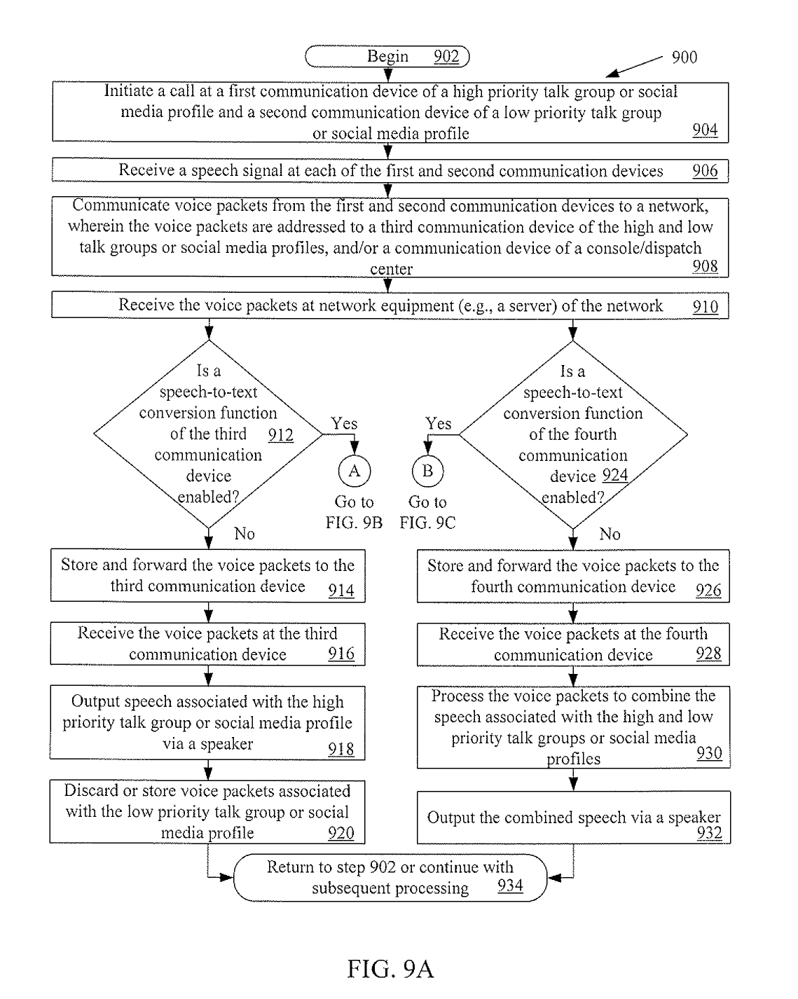

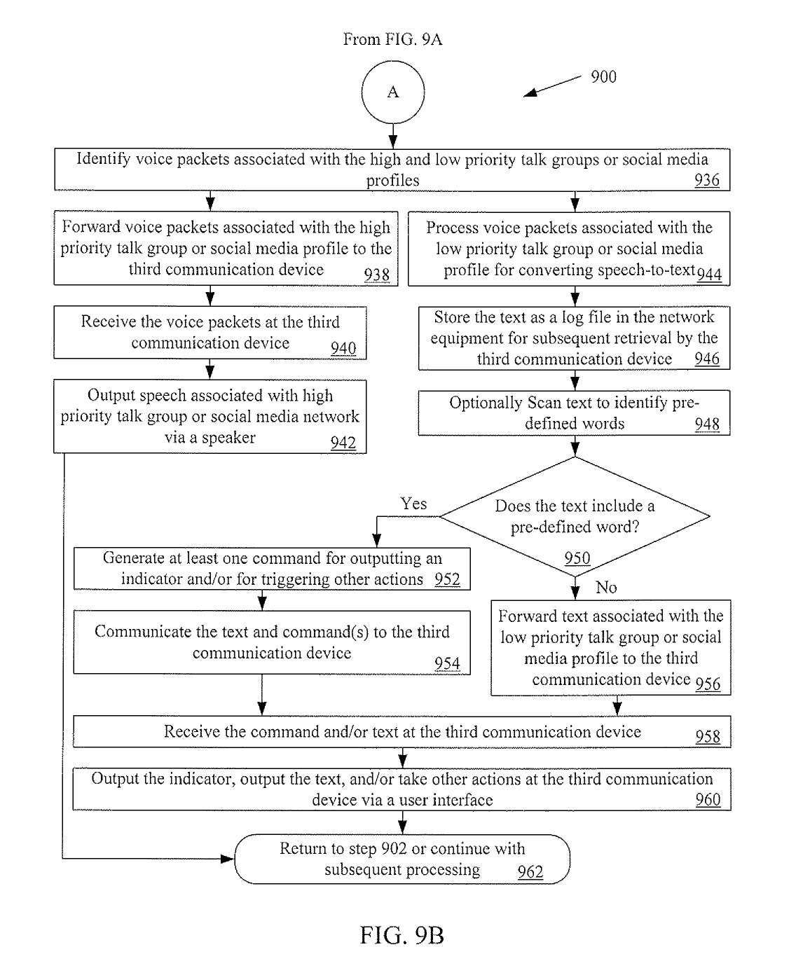

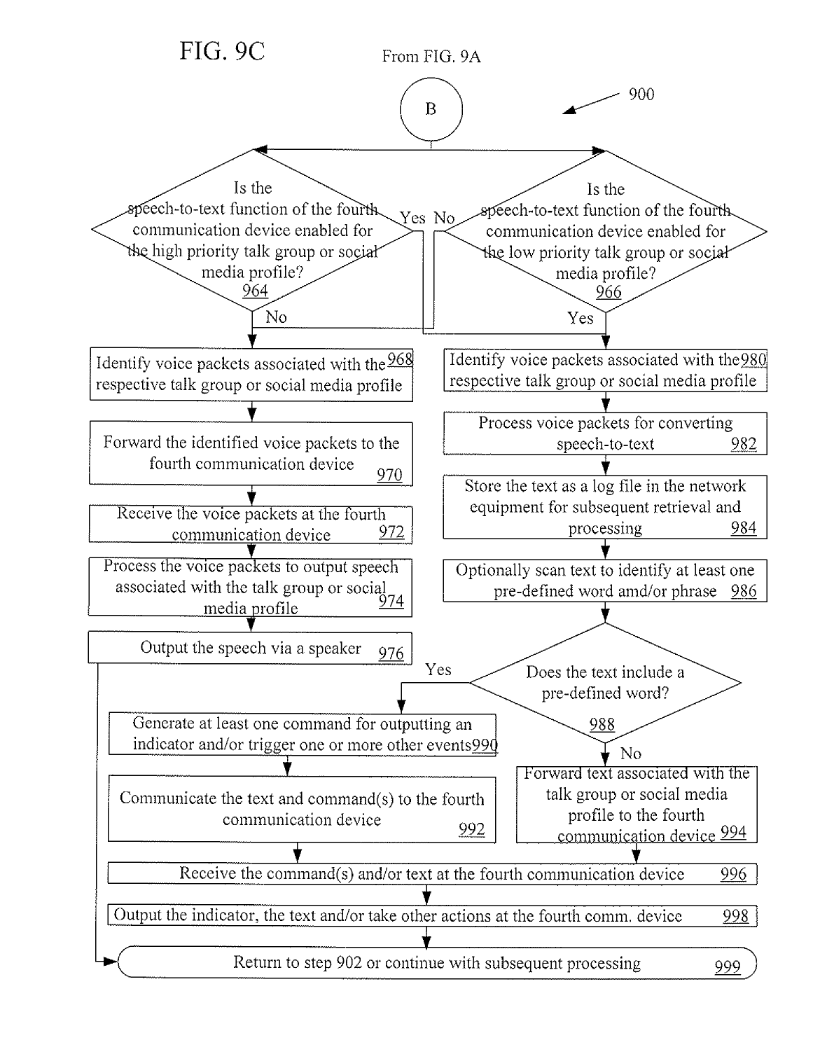

Each set of FIGS. 8A-8C and 9A-9C provides a flow diagram of an exemplary method for providing group calls using a communication system (e.g., the communication system 100) that is useful for understanding the present invention. More particularly, FIGS. 8A-8C show an exemplary method in which the communication devices (e.g., communication devices 102, 106, 108, 112 of FIG. 1) perform speech-to-text conversion operations. FIGS. 9A-9C show an exemplary method in which network equipment (e.g., server 114 of FIG. 1) of a network (e.g., network 104 of FIG. 1) perform speech-to-text conversion operations.

Referring now to FIGS. 8A-8C, there is provided a flow diagram of a first exemplary method 800 for providing group calls that is useful for understanding the present invention. As shown in FIG. 8A, the method 800 begins at step 802 and continues with step 804. In step 804, a group call is initiated at a first communication device of a high priority talk group “HTG-1” or social media profile “HSMP-1”. Also, a group call is initiated at a second communication device of a low priority talk group “LTG-2” or low priority social media profile “LSMP-2”. Thereafter, users of the first and second communication devices speak into microphones thereof. In effect, speech signals are received at the first and second communication devices in step 806. Next, step 808 is performed where voice packets are communicated from each of the first and second communication devices to a third communication device via a network. The third communication device is a member of the high priority talk group “HTG-1” or high priority social media profile “HSMP-1”. The third communication device is also a member of the low priority talk group “LTG-2” or low priority social media profile “LSMP-2”. The voice packets can also be communicated from each of the first and second communication devices to a fourth communication device of a console/dispatch center. If the voice packets are communicated to the fourth communication device of the console/dispatch center, then the method 800 continues with step 832 of FIG. 8B.

Referring now to FIG. 8B, step 832 involves receiving the voice packets communicated from the first and second communication devices at the fourth communication device of the console/dispatch center. After receiving the voice packets, decision steps 834 and 838 are performed. Decision step 834 is performed to determine if a speech-to-text conversion function for the high priority talk group “HTG-1” or high priority social media profile “HSMP-1” is enabled. If the speech-to-text conversion function is not enabled for the high priority talk group “HTG-1” or high priority social media profile “HSMP-1” [834:NO], then step 836 is performed. In step 836, speech associated with the high priority talk group “HTG-1” or high priority social media profile “HSMP-1” is output to a user of the fourth communication device via a user interface (e.g., a speaker) thereof. If the speech-to-text conversion function is enabled for the high priority talk group “HTG-1” or high priority social media profile “HSMP-1” [834:YES], then the method 800 continues with step 842, which will be described below.

Step 838 is performed to determine if a speech-to-text conversion function is enabled for the low priority talk group “LTG-2” or low priority social media profile “LSMP-1”. If the speech-to-text conversion function is not enabled for the low priority talk group “LTG-2” or low priority social media profile “LSMP-1” [838:NO], then step 840 is performed. In step 840, speech associated with the low priority talk group “LTG-2” or low priority social media profile “LSMP-1” is output to a user of the fourth communication device via a user interface (e.g., a speaker) thereof. If the speech-to-text conversion function is enabled for the low priority talk group “LTG-2” or low priority social media profile “LSMP-1” [838:YES], then the method 800 continues with step 842.

Step 842 involves processing the voice packets to convert speech into text. Next, an optional step 844 is performed where the text is scanned to identify one or more pre-defined or pre-selected words and/or phrases. Upon completing the scan of the text, a decision step 846 is performed to determine if a pre-defined or pre-selected word and/or phrase was identified in the text. If the text contains at least one pre-defined or pre-selected word and/or phrase [846:YES], then step 848 is performed where an indicator is output to a user of the fourth communication device. The indicator can include, but is not limited to, an audible indicator and a visible indicator. Step 848 can additionally or alternatively involve triggering other actions (e.g., data logging and email forwarding). Subsequently, step 850 is performed which will be described below.

If the text does not contain one or more pre-defined or pre-selected words and/or phrases [846:NO], then step 850 is performed where the text is stored in a storage device of the fourth communication device. The text can be stored as a text string. Step 850 also involves outputting the text to the user of the fourth communication device via a user interface. Thereafter, step 852 is performed where the method 800 returns to step 802 or subsequent processing is performed.

Referring again to FIG. 8A, a decision step 812 is performed subsequent to receiving the voice packets communicated from the first and second communication device at the third communication device in step 810. The decision step 812 is performed to determine if the third communication device is in its muted state. If the third communication device is not in its muted state [812:NO], then the method 800 continues with a decision step 854 of FIG. 8C, which will be described below. If the third communication device is in its muted state [812:YES], then the method 800 continues with a decision step 816. Decision step 816 is performed to determine if a speech-to-text conversion function of the third communication device is enabled. If the speech-to-text conversion function of the third communication device is not enabled [816:NO], then step 818 is performed where the voice packets are discarded or stored in a storage device of the third communication device. Thereafter, step 830 is performed where the method 800 returns to step 802 or subsequent processing is performed.

If the speech-to-text conversion function of the third communication device is enabled [816:YES], then the method 800 continues with step 820. In step 820, the voice packets are processed to convert speech to text. Next, an optional step 822 is performed where the text is scanned to identify one or more pre-defined or pre-selected words and/or phrases. Upon completing the scan of the text, a decision step 824 is performed to determine if the pre-defined or pre-selected word and/or phrase was identified in the text. If the text contains at least one pre-defined or pre-selected word and/or phrase [824:YES], then step 826 is performed where an indicator is output to a user of the third communication device. The indicator can include, but is not limited to, a visible indicator and an audible indicator. Step 826 can additionally or alternatively involve triggering other actions (e.g., data logging and email forwarding). Subsequently, step 828 is performed which will be described below.

If the text does not contain one or more pre-defined or pre-selected words and/or phrases [824:NO], then step 828 is performed where the text is stored in a storage device of the third communication device. The text can be stored as a text string. Step 828 also involves outputting the text to the user of the third communication device via a user interface. Thereafter, step 830 is performed where the method 800 returns to step 802 or subsequent processing is performed.

Referring now to FIG. 8C, decision step 854 is performed to determine if a speech-to-text conversion function of the third communication device is enabled. As noted above, step 854 is performed if the third communication device is not in its muted state. If the speech-to-text conversion function of the third communication device is not enabled [854:NO], then step 856 is performed where the speech associated with the high priority talk group “HTG-1” or high priority social media profile “HSMP-1” is output to a user of the third communication device via a user interface (e.g., a speaker). In a next step 858, voice packets associated with the low priority talk group “LTG-2” or low priority social media profile “LSMP-2” are discarded or stored in a storage device of the third communication device. Thereafter, step 872 is performed where the method 800 returns to step 802 or subsequent processing is performed.

If the speech-to-text conversion function of the third communication device is enabled [854:YES], then step 860 is performed where speech associated with the high priority talk group “HTG-1” or high priority social media profile “HSMP-1” is output to a user of the third communication device via a user interface thereof (e.g., a speaker). In a next step 862, the voice packets associated with the low priority talk group “LTG-2” or low priority social media profile “LSMP-2” are processed to convert text to speech. Next, an optional step 864 is performed where the text is scanned to identify one or more pre-defined or pre-selected words and/or phrases. Upon completing the scan of the text, a decision step 866 is performed to determine if at least one pre-defined or pre-selected word and/or phrase was identified in the text. If the text contains at least one pre-defined or pre-selected word and/or phrase [866:YES], then step 868 is performed where an indicator is output to a user of the third communication device. The indicator can include, but is not limited to, a visible indicator and an audible indicator. Step 868 can additionally or alternatively involve triggering one or more other events (e.g., data logging and email forwarding). Subsequently, step 870 is performed which will be described below.

If the text does not contain one or more pre-defined or pre-selected words and/or phrases [866:NO], then step 870 is performed where the text is stored in a storage device of the third communication device. The text can be stored as a text string. Step 870 can also involve outputting the text to the user of the third communication device via a user interface. Thereafter, step 872 is performed where the method 800 returns to step 802 or subsequent processing is performed.

Referring now to FIGS. 9A-9C, there is provided a flow diagram of a second exemplary method 900 for providing group calls that is useful for understanding the present invention. As shown in FIG. 9A, the method 900 begins at step 902 and continues with step 904. In step 904, a group call is initiated by a first communication device of a high priority talk group “HTG-1” or high priority social media profile “HSMP-1”. A group call is also initiated at a second communication device of a low priority talk group “LTG-2” or low priority social media profile “LSMP-2”. Thereafter, users of the first and second communication devices speak into microphones thereof. In effect, speech signals are received at the first and second communication devices in step 906. Next, step 908 is performed where voice packets are communicated from each of the first and second communication devices to a network. Notably, the voice packets are addressed to a third communication device of the high and low priority talk groups “HTG-1”, “LTG-2” or social media profiles “HSMP-1”, “LSMP-2”. The voice packets can also be addressed to a fourth communication device of a dispatch center.

After receiving the voice packets at network equipment of the network in step 910, decision steps 912 and 924 are performed. Decision step 912 is performed to determine if a speech-to-text conversion function of the third communication device is enabled. If the speech-to-text conversion function of the third communication device is not enabled [912:NO], then the step 914 is performed where the voice packets are forwarded to the third communication device. Step 914 can also involve storing the voice packets associated with one or more of the talk groups “HTG-1”, “LTG-2” or social media profiles “HSMP-1”, “LSMP-2” in a storage device of the network for subsequent retrieval and processing thereby.

In a next step 916, the voice packets are received at the third communication device. Thereafter, the voice packets are processed in step 918 to output speech associated with the high priority talk group “HTG-1” or high priority social media profile “HSMP-1” to a user of the third communication device. The speech associated with the high priority talk group “HTG-1” or high priority social media profile “HSMP-1” is output to the user via a user interface of the third communication device. If the voice packets associated with the low priority talk group “LTG-2” or low priority social media profile “LSMP-2” are also communicated to the third communication device, then step 920 is performed where these voice packet are discarded or stored in a storage device of the third communication device. Upon completing step 920, step 934 is performed where the method 900 returns to step 902 or subsequent processing is performed.

If the speech-to-text conversion function of the third communication device is enabled [912:YES], then the method 900 continues with step 936 of FIG. 9B. Referring now to FIG. 9B, step 936 involves identifying voice packets associated with the high and low priority talk group “HTG-1”, “LTG-2” or social media profiles “HSMP-1”, “LSMP-2”. Upon completing step 936, the method 900 continues with steps 938 and 944.

Step 938 involves forwarding voice packets associated with the high priority talk group “HTG-1” or high priority social media profile “HSMP-1” to the third communication device. In step 940, the voice packets are received at the third communication device. At the third communication device, the voice packets are processed to output speech associated with the high priority talk group “HTG-1” or high priority social media profile “HSMP-1” to a user of the third communication device. The speech can be output via a user interface (e.g., a speaker). Thereafter, step 962 is performed where the method 900 returns to step 902 or subsequent processing is performed.

Step 944 involves processing the voice packets associated with the low priority talk group “LTG-2” or low priority social media profile “LSMP-2” for converting speech to text. In a next step 946, the text is stored in a storage device of the network for subsequent retrieval and processing thereby. The text can be stored in a log file of the storage device. Thereafter, an optional step 948 is performed where the text is scanned to identify at least one pre-defined or pre-selected word or phrase.

If one or more pre-defined or pre-selected words or phrases was identified [950:YES], then step 952 is performed where the network equipment generates at least one command for outputting an indicator and/or triggering other events (e.g., data logging and email forwarding). The text and command(s) are then communicated from the network to the third communication device in step 954. After receipt of the text and command(s) at the third communication device in step 958, the text and/or an indicator is output to a user thereof in step 960. The indicator can include, but is not limited to, an audible indicator and a visible indicator. Step 960 can also involve taking other actions (e.g., data logging and email forwarding) at the third communication device. Subsequently, step 962 is performed where the method 900 returns to step 902 or subsequent processing is performed.

If one or more pre-defined or pre-selected words or phrases was not identified [950:NO], then step 956 is performed where the text associated with the low priority talk group “LTG-2” or low priority social media profile “LSMP-2” is forwarded from the network to the third communication device. After receipt of the text at the third communication device in step 958, step 960 is performed. In step 960, the text associated with the low priority talk group “LTG-2” or low priority social media profile “LSMP-2” is output to a user of the third communication device via a user interface. Thereafter, step 962 is performed where the method 900 returns to step 902 or subsequent processing is performed.

Referring again to FIG. 9A, the decision step 924 is performed to determine if a speech-to-text conversion function of the fourth communication device is enabled. If the speech-to-text conversion function of the fourth communication device is not enabled [924:NO], then step 926 is performed where the voice packets are forwarded from the network to the fourth communication device. Notably, the voice packets include voice packets associated with the high and low priority talk groups “HTG-1”, “LTG-2” or priority social media profiles “HSMP-1”, “LSMP-2”. After receiving the voice packets at the fourth communication device in step 928, step 930 is performed where the voice packets are processed to combine the speech associated with the talk groups “HTG-1”, “LTG-2” or priority social media profiles “HSMP-1”, “LSMP-2”. The combined speech is then output to a user of the fourth communication device in step 932. Thereafter, step 934 is performed where the method 900 returns to step 902 or subsequent processing is performed.

If the speech-to-text conversion function of the fourth communication device is not enabled [924:YES], then the method 900 continues with steps 964 and 966 of FIG. 9C. Referring now to FIG. 9C, step 964 is performed to determine if the speech-to-text conversion function of the fourth communication device is enabled for the high priority talk group “HTG-1” or high priority social media profile “HSMP-1”. If the speech-to-text conversion function of the fourth communication device is enabled for the high priority talk group “HTG-1” or high priority social media profile “HSMP-1” [964:YES], then the method 900 continues with steps 980-999 which will be described below.

If the speech-to-text conversion function of the fourth communication device is not enabled for the high priority talk group “HTG-1” or high priority social media profile “HSMP-1” [964:NO], then the method 900 continues with step 968. Step 968 involves identifying voice packets associated with the respective talk group (e.g., high priority talk group “HTG-1”) or social media profile (e.g., high priority social media profile “HSMP-1”). In a next step 970, the identified voice packets associated with the respective talk group or social media profile are forwarded from the network to the fourth communication device. After receiving the voice packets at the fourth communication device in step 972, step 974 is performed where the voice packets are processed to output speech associated with the respective talk group or social media profile to a user of the fourth communication device. In step 976, the speech associated with the respective talk group or social media profile is output via a user interface of the communication device. Thereafter, step 999 is performed where the method 900 returns to step 902 or subsequent processing is performed.

The decision step 966 is performed to determine if a speech-to-text conversion function of the fourth communication device is enabled for the low priority talk group “LTG-2” or low priority social media profile “LSMP-2”. If the speech-to-text conversion function of the fourth communication device is not enabled for the low priority talk group “LTG-2” or low priority social media profile “LSMP-2” [966:NO], then the method continues with steps 968-999 which are described above. If the speech-to-text conversion function of the fourth communication device is enabled for the low priority talk group “LTG-2” or low priority social media profile “LSMP-2” [966:YES], then the method continues with step 980.

Step 980 involves identifying voice packets associated with a respective talk group (e.g., low priority talk group “LTG-2”) or social media profile (e.g., low priority social media profile “LSMP-2”). In a next step 982, the identified packets are processed for converting speech to text. The text can be stored as a log file in a storage device of the network in step 984. As such, the text can be subsequently retrieved and processed by the network equipment and/or other communication devices. After completing step 984, an optional step 986 is performed where the text is scanned to identify at least one pre-defined or pre-selected word or phrase.

If one or more pre-defined or pre-selected words or phrases was identified [988:YES], then step 990 is performed where the network equipment generates at least one command for outputting an indicator and/or triggering one or more other events (e.g., data logging and email forwarding). The text and command(s) are then communicated from the network to the fourth communication device in step 992. After receipt of the text and command(s) at the fourth communication device in step 996, the text and/or at least one indicator is output to a user of the fourth communication device in step 998. The indicator can include, but is not limited to, an audible indicator and a visible indicator. Step 998 can also involve taking other actions (e.g., data logging and email forwarding) at the fourth communication device. Subsequently, step 999 is performed where the method 900 returns to step 902 or subsequent processing is performed.

If one or more pre-defined or pre-selected words or phrases was not identified [988:NO], then step 994 is performed where the text associated with the respective talk group (e.g., the low priority talk group “LTG-2”) or social media profile (e.g., low priority social media profile “LSMP-2”) is forwarded from the network to the fourth communication device. After receipt of the text at the fourth communication device in step 996, step 998 is performed. In step 998, the text associated with the respective talk group (e.g., the low priority talk group “LTG-2”) or social media profile (e.g., low priority social media profile “LSMP-2”) is output to a user of the fourth communication device via a user interface. Thereafter, step 999 is performed where the method 900 returns to step 902 or subsequent processing is performed.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for minimizing loss of voice data in a Land Mobile Radio (LMR) communication system in which individual LMR devices are assigned to more than one talk group, comprising:
receiving a first transmitted voice communication from a first LMR device for a first talk group to which said first LMR device and a second LMR device have been assigned;
receiving a second transmitted voice communication from a third LMR device for a second talk group to which said first LMR device and said third LMR device have been assigned, said second transmitted voice communication occurring at a time at least partially concurrent with said first transmitted voice communication; and
responsive to concurrently receiving said first and second transmitted voice communications, automatically preserving a speech information content of said second transmitted voice communication by performing at least one action.

2. The method according to claim 1, wherein said action comprises converting said speech information content to text.

3. The method according to claim 2, wherein said action further comprises displaying said text at said second LMR device.

4. The method according to claim 2, wherein said converting is performed at said second LMR device.

5. The method according to claim 2, wherein said converting is performed at a network server remote from said second LMR device.

6. The method according to claim 2, further comprising providing at least one time stamp for said text.

7. The method according to claim 2, further comprising providing at least one identifier for said text to associate said text with said third LMR device.

8. The method according to claim 2, wherein said action further comprises storing said text for subsequent use.

9. The method according to claim 8, wherein said action further comprises converting said text, which has been stored, to speech and presenting said speech as audio at said second LMR device.

10. The method according to claim 1, wherein said action comprises storing said speech information content for later presentation at said second LMR device.

11. The method according to claim 1, further comprising:
if an audio output of said second LMR device is set to a mute condition, automatically converting to text at least one of said first transmitted voice communication and said second transmitted voice communication.

12. The method according to claim 1, further comprising generating at least one signal to notify a user that said preserving step has been performed.

13. A method for minimizing loss of voice data in a Land Mobile Radio (LMR) communication system in which individual LMR devices are assigned to more than one talk group, comprising:
receiving a first transmitted voice communication from a first LMR device for a first talk group to which said first LMR device and a second LMR device have been assigned;
determining if a condition exists which prevents audio from said first transmitted voice communication from being played over a loudspeaker at said second LMR device; and
if said condition exists, automatically preserving a speech information content of said first transmitted voice communication by performing at least one action.

14. The method according to claim 13, wherein said action comprises converting said speech information content to text.

15. The method according to claim 14, wherein said action further comprises displaying said text at said second LMR device.

16. The method according to claim 14, wherein said converting is performed at said second LMR device.

17. The method according to claim 14, wherein said converting is performed at a network server remote from said second LMR device.

18. The method according to claim 14, further comprising providing at least one time stamp for said text.

19. The method according to claim 14, further comprising providing at least one identifier for said text to associate said text with said second LMR device.

20. The method according to claim 14, wherein said action further comprises storing said text for subsequent use.

21. The method according to claim 20, wherein said action further comprises converting said text, which has been stored, to speech and presenting said speech as audio at said second LMR device.

22. The method according to claim 13, wherein said action comprises storing said speech information content for later presentation at said second LMR device.

23. The method according to claim 13, wherein said condition comprises receiving a second transmitted voice communication from a third LMR device for a second talk group to which said second LMR device and said third LMR device have been assigned, said second transmitted voice communication occurring at a time at least partially concurrent with said first transmitted voice communication.

24. The method according to claim 13, further comprising generating at least one signal to notify a user of said second LMR device that said preserving step has been performed.

25. A method for minimizing loss of voice data in a communication system in which individual communication devices are assigned to more than one social media profiles, comprising:
receiving a first transmitted voice communication from a first communication device for a first social media profile to which said first communication device and a second communication device have been assigned;
receiving a second transmitted voice communication from a third communication device for a second social media profile to which said first communication device and said third communication device have been assigned, said second transmitted voice communication occurring at a time at least partially concurrent with said first transmitted voice communication; and
responsive to concurrently receiving said first and second transmitted voice communications, automatically preserving a speech information content of said second transmitted voice communication by performing at least one action.

26. A method for minimizing loss of voice data in a communication system in which individual communication devices are assigned to more than one social media profile, comprising:
receiving a first transmitted voice communication from a first communication device for a first social media profile to which said first communication device and a second communication device have been assigned;
determining if a condition exists which prevents audio from said first transmitted voice communication from being played over a loudspeaker at said second communication device; and
if said condition exists, automatically preserving a speech information content of said first transmitted voice communication by performing at least one action.

27. A Land Mobile Radio (LMR) communication system in which individual LMR devices of a plurality of LMR devices are assigned to more than one talk group, comprising:
a receiver configured for
(a) receiving a first transmitted voice communication from a first LMR device for a first talk group to which said first LMR device and a second LMR device have been assigned, and
(b) receiving a second transmitted voice communication from a third LMR device for a second talk group to which said first LMR device and said third LMR device have been assigned, said second transmitted voice communication occurring at a time at least partially concurrent with said first transmitted voice communication; and
at least one processor configured to automatically preserve a speech information content of said second transmitted voice communication by performing at least one action in response to said concurrent reception of said first and second transmitted voice communications at said receiver.

28. The LMR communication system according to claim 27, wherein said action comprises converting said speech information content to text.

29. The LMR communication system according to claim 28, wherein said action further comprises displaying said text at said second LMR device.

30. The LMR communication system according to claim 28, wherein said converting is performed at said second LMR device.

31. The LMR communication system according to claim 28, wherein said converting is performed at a network server remote from said second LMR device.

32. The LMR communication system according to claim 28, wherein said action further comprises providing at least one time stamp for said text.

33. The LMR communication system according to claim 28, wherein said action further comprises providing at least one identifier for said text to associate said text with said third LMR device.

34. The LMR communication system according to claim 28, wherein said action further comprises storing said text for subsequent use.

35. The LMR communication system according to claim 34, wherein said action further comprises converting said text, which has been stored, to speech and presenting said speech as audio at said second LMR device.

36. The LMR communication system according to claim 27, wherein said action comprises storing said speech information content for later presentation at said second LMR device.

37. The LMR communication system according to claim 27, wherein said processor is further configured for automatically converting to text at least one of said first transmitted voice communication and said second transmitted voice communication if an audio output of said second LMR device is set to a mute condition.
